(19) United States
(12) Patent Application Publication
(10) Pub. No.: US 2026/0146543 A1
(43) Pub. Date: May 28, 2026

(54) FLUID FLOW MACHINE AND RELATED METHOD

(71) Applicant: ROLLS-ROYCE plc, London (GB)

(72) Inventor: Duncan E. ASHLEY, Bristol (GB)

(73) Assignee: ROLLS-ROYCE plc, London (GB)

(21) Appl. No.: 19/376,364

(22) Filed: Oct. 31, 2025

(30) Foreign Application Priority Data
Nov. 22, 2024 (GB) 2417179.5

(51) Int. Cl. F01D 11/00

(52) U.S. Cl. CPC F01D 11/001; F05D 2230/60; F05D 2240/55; F05D 2300/431; F05D 2300/603

(57) ABSTRACT

A fluid flow machine including a first rotor and a stator alongside the first rotor, each of the first rotor and the stator including circumferentially distributed turbomachine blades, wherein the stator includes a stator shroud structure including a stator shroud surface and the first rotor includes a first rotor shroud structure including a first rotor shroud surface, the stator shroud surface and first rotor shroud surface together at least partially defining a radially inner flow surface of the fluid flow machine, wherein the first rotor shroud structure defines a first cavity, the first cavity being disposed radially inward of the first rotor shroud surface, and wherein the stator shroud structure includes a first protrusion, the first protrusion being disposed radially inward of the radially inner flow surface, wherein the first protrusion extends in a direction with an axial component and into the first cavity of the first rotor shroud structure.

This disclosure claims the benefit of UK Patent Application No. GB 2417179.5 filed on 22 Nov. 2024, which is hereby incorporated herein in its entirety.

### CROSS REFERENCE TO RELATED APPLICATIONS

This represents the first application directed towards the subject-matter.

### FIELD

This disclosure relates to a fluid flow machine (e.g., a compressor, turbine or gas turbine engine) comprising a stator shroud structure with a protrusion that extends into a cavity of a rotor shroud structure. This disclosure further relates to a method for, and a vehicle (e.g., an aircraft) comprising, such a fluid flow machine.

### BACKGROUND

Compressor rotors typically have voids or cavities on the inside of the primary gas-path shroud to facilitate build and provide volume for mechanical coupling of the inner end of the stators. Rotating seals are usually positioned here to prevent high-pressure air from running back under the stators to the lower-pressure region at the stator inlet, from where it will form a jet back into the primary gas path that can disturb the flow and lead to inefficiencies. These voids or cavities have their own aero-acoustic characteristics that can make primary gas-path disruption more severe and changing their volume may modify how these cavities behave.

The present invention has been devised with the foregoing in mind.

### SUMMARY

According to a first aspect there is provided a fluid flow machine comprising a first rotor and a stator positioned alongside the first rotor, each of the first rotor and the stator comprising a plurality of circumferentially distributed turbomachine blades,
wherein the stator comprises a stator shroud structure comprising a stator shroud surface and the first rotor comprises a first rotor shroud structure comprising a first rotor shroud surface, the stator shroud surface and first rotor shroud surface together at least partially defining a radially inner flow surface of the fluid flow machine,
wherein the first rotor shroud structure defines a first cavity, the first cavity being disposed radially inward of the first rotor shroud surface, and
the stator shroud structure comprises a first protrusion, the first protrusion being disposed radially inward of the radially inner flow surface, wherein the first protrusion extends in a direction with an axial component and into the first cavity of the first rotor shroud structure, and wherein the first protrusion may be resiliently deformable.

In an embodiment, the first protrusion may be resiliently deformable such that the first protrusion may be resiliently deformed by an axial edge of the first rotor shroud structure when the stator is radially moved into position during assembly or moved out of position during disassembly.

In an embodiment, the first protrusion may be formed from a fibre-reinforced silicone rubber.

In an embodiment, the first protrusion may be at least partially hollow.

In an embodiment, the first protrusion may comprise a foam filler provided in the hollow of the first protrusion.

In an embodiment, the first protrusion may substantially follow the shape of the first cavity.

In an embodiment, the first protrusion may extend beyond an axial edge of the first rotor shroud structure such that a distal end of the first protrusion may be set back from the axial edge of the first rotor shroud structure when the stator is in an installed position relative to the first rotor.

In an embodiment, the stator shroud structure may comprise a shroud ring that supports turbomachine blades of the stator. In an embodiment, the first protrusion may extend from a first end face of the shroud ring.

In an embodiment, the fluid flow machine may comprise a seal between the stator shroud structure and the first rotor shroud structure.

In an embodiment, the fluid flow machine may further comprise a second rotor comprising a plurality of circumferentially distributed turbomachine blades, the stator being positioned between the first and second rotors. The second rotor may comprise a second rotor shroud structure comprising a second rotor shroud surface. The stator shroud surface and first and second rotor shroud surfaces may together at least partially define the radially inner flow surface of the fluid flow machine.

In an embodiment, the second rotor shroud structure may define a second cavity. The second cavity may be disposed radially inward of the second rotor shroud surface.

In an embodiment, the stator shroud structure may comprise a second protrusion. The second protrusion may be disposed radially inward of the radially inner flow surface. The second protrusion may extend in a direction with an axial component and into the second cavity of the second rotor shroud structure.

In an embodiment, any of the features relating to the first protrusion may apply to the second protrusion and/or any of the features relating to the first rotor may apply to the second rotor.

According to a second aspect there is provided a stator shroud structure for a fluid flow machine comprising a stator and a first rotor, the stator shroud structure being configured to support a plurality of circumferentially distributed turbomachine blades,
wherein the stator shroud structure comprises a stator shroud surface at least partially defining a radially inner flow surface of the fluid flow machine,
wherein the stator shroud structure comprises a first protrusion, the first protrusion being disposed radially inward of the radially inner flow surface, wherein the first protrusion extends in a direction with an axial component (e.g. in a substantially axial direction of the stator shroud structure) and beyond an edge of the stator shroud surface.

According to a third aspect there is provided a compressor, turbine, gas turbine engine, vehicle or aircraft comprising the fluid flow machine or stator shroud structure.

According to a fourth aspect there is provided a method of assembling a fluid flow machine comprising a first rotor and a stator positionable alongside the first rotor, each of the first rotor and the stator comprising a plurality of circumferentially distributed turbomachine blades,
wherein the stator comprises a stator shroud structure comprising a stator shroud surface and the first rotor comprises a first rotor shroud structure comprising a first rotor shroud surface, the stator shroud surface and first rotor shroud surface together at least partially defining a radially inner flow surface of the fluid flow machine,
wherein the first rotor shroud structure defines a first cavity, the first cavity being disposed radially inward of the first rotor shroud surface, and
wherein the stator shroud structure comprises a first protrusion, the first protrusion being disposed radially inward of the radially inner flow surface,
the method comprising positioning the stator such that the first protrusion extends in a direction with an axial component and into the first cavity of the first rotor shroud structure.

### BRIEF DESCRIPTION OF THE DRAWINGS

Embodiments will now be described by way of example only with reference to the accompanying drawings in which:

FIG. 1 is a simplified view of an aircraft comprising a gas turbine engine;

FIG. 2 is a sectional view of an example gas turbine engine;

FIG. 3 is detail section view of a previously-proposed fluid flow machine, such as in the gas turbine engine of FIG. 2;

FIG. 4 is a detail section view of a further fluid flow machine; and

FIG. 5 is a flow chart depicting a method of assembling the further fluid flow machine.

### DETAILED DESCRIPTION

### Aircraft

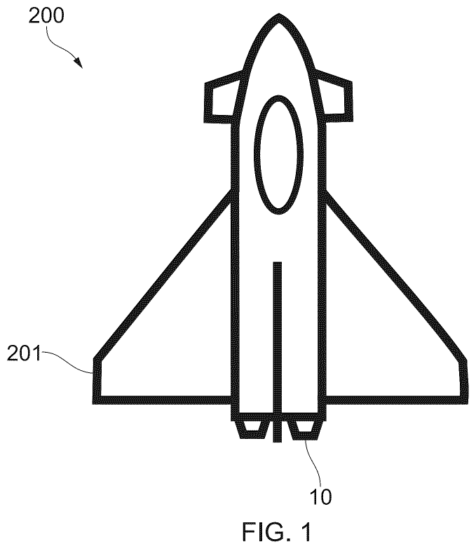

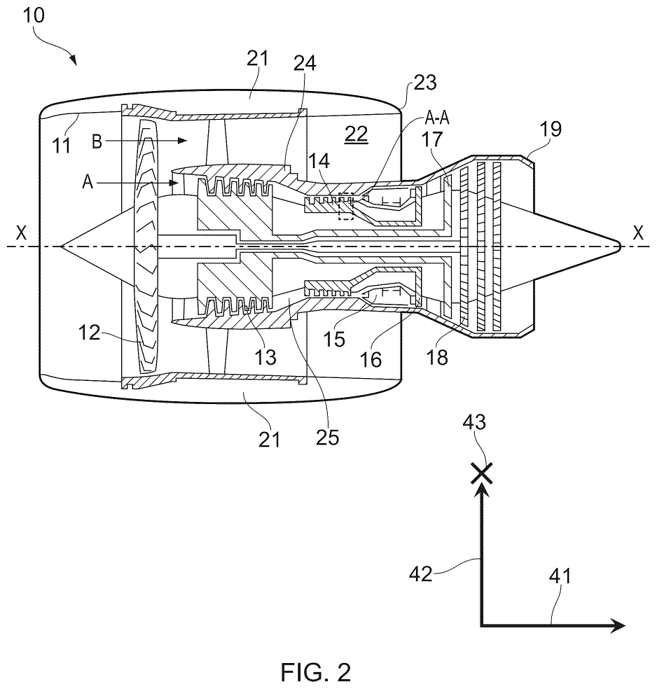

FIG. 1 shows a simplified and schematic view of an aircraft 200 comprising an airframe 201 and a gas turbine engine 10. The gas turbine engine 10 may be in accordance with the gas turbine engine 10 described below with reference to FIGS. 2 to 4.

### Gas Turbine Engine

FIG. 2 shows an example ducted fan gas turbine engine 10 having a principal and rotational axis X-X. The gas turbine engine 10 is suitable for use with the aircraft 200 described above with FIG. 1. The engine comprises, in axial flow series, an air intake 11, a propulsive fan 12, an intermediate-pressure compressor 13, a high-pressure compressor 14, a combustor 15, a high-pressure turbine 16, an intermediate pressure turbine 17, a low-pressure turbine 18 and a core engine exhaust outlet 19. A nacelle 21 generally surrounds the gas turbine engine 10 and defines the intake 11, a bypass duct 22 and a bypass exhaust outlet 23.

During operation, air entering the intake 11 is accelerated by the fan 12 to produce two gas flows: a first gas flow A into the intermediate pressure compressor 13 and a second gas flow B which passes through the bypass duct 22 to provide propulsive thrust. The intermediate-pressure compressor 13 compresses the gas flow A directed into it before delivering that air to the high-pressure compressor 14 where further compression takes place.

The compressed air exhausted from the high-pressure compressor 14 is directed into the combustor 15 where it is mixed with fuel and the mixture combusted. The resultant hot combustion products then expand through, and thereby drive the high, intermediate and low-pressure turbines 16, 17, 18 before being exhausted through the core engine exhaust outlet 19 to provide additional propulsive thrust. The high, intermediate and low-pressure turbines 16, 17, 18 respectively drive the high and intermediate pressure compressors 13, 14 and the fan 12 by suitable interconnecting shafts.

A casing structure 24 surrounds the compressors 13, 14, the combustor 15 and the turbines 16, 17, 18 to separate the bypass duct 22 from a core duct 25. The casing structure 24 therefore extends around an axial direction 41 of the gas turbine engine 10. The casing structure 24 may also be referred to as a support duct.

As will be appreciated by those skilled in the art, the axial direction 41 corresponds (e.g., is parallel to) to the principal rotational axis X-X. An angular (e.g. circumferential) direction 43 of the gas turbine engine 10 corresponds to a direction of rotation of the turbines 16, 17, 18 and the compressors 13, 14 (and the interconnecting shafts therebetween) around the principal rotational axis X-X in use. A radial direction 42 of the gas turbine engine 10 extends away from the principal rotational axis X-X and is mutually perpendicular to both the axial direction 41 and the angular direction 43. As will also be appreciated by those skilled in the art, each compressor 13, 14 and turbine 16, 17, 18 comprises one or more rotor and stator pairs, with each rotor having a plurality of blades (i.e., turbomachine blades). The axial direction 41, radial direction 42 and angular direction 43 are indicated on each of FIGS. 2 to 4.

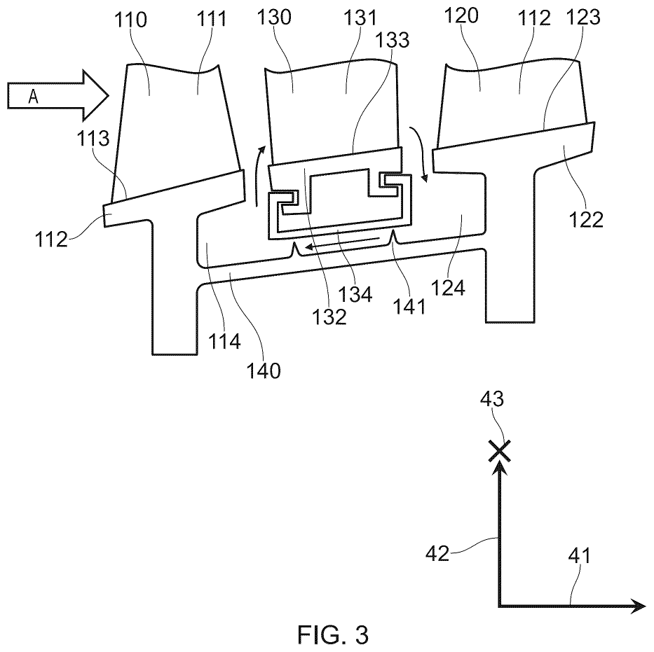

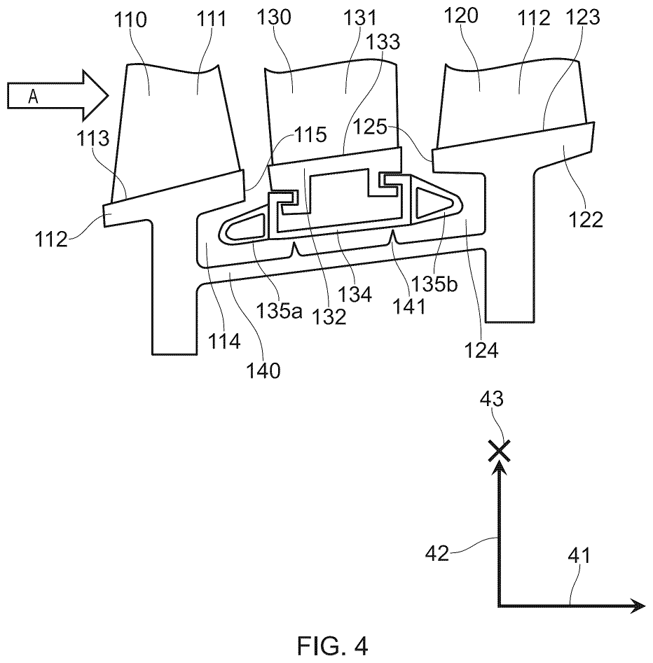

The following description is provided with particular reference to FIGS. 3 and 4. FIGS. 3 and 4 are sectional views of the example gas turbine engine of FIG. 2 as indicated by region A-A on FIG. 2. Although region A-A relates to the high-pressure compressor 14, it is also envisaged that the present teachings may apply to other (e.g. rotary) fluid flow machines, such as the intermediate-pressure compressor 13 or any of the turbines 16, 17, 18.

As depicted in FIGS. 3 and 4, the fluid flow machine comprises a first rotor 110 and a second rotor 120 either side of a stator 130. Each of the first rotor 110, second rotor 120 and stator 130 comprise a plurality of circumferentially distributed turbomachine blades 111, 121, 131. Although FIGS. 3 and 4 depict a pair of rotors, it is also envisaged that the present disclosure may apply to a single rotor and stator, e.g. in which one of the first and second rotors is omitted.

The first rotor 110 comprises a first rotor shroud structure 112 comprising a first rotor shroud surface 113. Likewise, the second rotor 120 comprises a second rotor shroud structure 122 comprising a second rotor shroud surface 123. The first rotor shroud structure 112 and second rotor shroud structure 122 may be connected to one another via a drive arm or drum 140.

The stator 130 comprises a stator shroud structure 132 comprising a stator shroud surface 133. The stator shroud surface 133 and first and second rotor shroud surfaces 113, 123 may together at least partially define a radially inner flow surface of the fluid flow machine. The radially inner flow surface together with a surface of a radially outer casing (not shown) may define a primary fluid flow path A through the fluid flow machine.

As shown, the first rotor shroud structure 112 defines a first cavity or void 114. The first cavity 114 may be disposed radially inward of the first rotor shroud surface 113, e.g. out of the primary flow path A. An axial edge 115 of the first rotor shroud structure 112 may overhang the first cavity 114. Likewise, the second rotor shroud structure 122 defines a second cavity or void 124. The second cavity 124 may be disposed radially inward of the second rotor shroud surface 123, e.g. out of the primary flow path A. An axial edge 125 of the second rotor shroud structure 122 may overhang the second cavity 124. The first and second cavities 114, 124 may extend in the circumferential direction 43 about the axial direction 41.

The stator shroud structure 132 may comprise a shroud ring 134 that may support radially inner ends of the stator turbomachine blades 131. The shroud ring 134 may be held by fixings on the radially inner ends of the stator turbomachine blades 131. The shroud ring 134 may face the drive arm 140. The shroud ring 134 may add stiffness to the stator turbomachine blades 131 by linking their inner platforms. The shroud ring 134 may be split into two separate portions to aid assembly. The stator turbomachine blades 131 may be held at their radially outer ends by the casing (not shown). The casing may also be split to aid assembly.

At least one seal may be between the stator shroud structure 132 and the rotors. In particular, at least one seal 141 may be provided between the shroud ring 134 and the drive arm 140.

As depicted in FIG. 3, a flow under the stator turbomachine blades 131 may be driven by a static pressure rise of the primary flow A across the stator 130. As shown by the arrows, a portion of the primary flow A may be driven into second cavity 124, which may then re-enter the primary flow path via the first cavity 114 and seal 141. This flow may interfere with the primary flow A across the stator 130.

Referring now to FIG. 4, the stator shroud structure 132 comprises a first protrusion 135a and a second protrusion 135b. The first and second protrusions 135a, 135b are disposed radially inward of the radially inner flow surface, e.g. such that they are spaced apart from the stator shroud surface 133 and out of the primary flow path A. In the particular embodiment shown, the first and second protrusions 135a, 135b may extend from respective first and second end faces of the shroud ring 134. The first and second protrusions 135a, 135b may extend in the circumferential direction 43 about the axial direction 41. It should be noted that although FIG. 4 depicts first and second protrusions 135a, 135b, it is also envisaged that only one of the protrusions may be provided.

The first and second protrusions 135a, 135b extend into respective first and second cavities 114, 124 of the first and second rotor shroud structures 112, 122. As such, the first and second protrusions 135a, 135b may extend in substantially opposite directions. The first and second protrusions 135a, 135b may extend in a direction with a component in the axial direction, e.g. in a substantially axial direction 41 of the flow machine. As depicted, the first and second protrusions 135a, 135b may extend in a direction with a radial component. In particular, the first protrusion 135a may extend in a direction from the stator shroud structure 132 with a radially inward component. By contrast, the second protrusion 135b may extend in a direction from the stator shroud structure 132 with a radially outward component.

The first protrusion 135a may extend beyond the axial edge 115 of the first rotor shroud structure 112 such that a distal end of the first protrusion 135a may extend beyond (and may be set back from) the axial edge 115 of the first rotor shroud structure 112 when the stator 130 is in an installed position relative to the first rotor 110. Likewise, the second protrusion 135b may extend beyond the axial edge 125 of the second rotor shroud structure 122 such that a distal end of the second protrusion 135b may extend beyond (and may be set back from) the axial edge 125 of the second rotor shroud structure 122 when the stator 130 is in an installed position relative to the second rotor 120.

The first and second protrusions 135a, 135b may at least partially fill the respective first and second cavities 114, 124. For example, the first and second protrusions 135a, 135b may approximately or substantially follow the shape of the respective first and second cavities 114, 124. By way of example, the first and second protrusions 135a, 135b may have an approximately D-shaped profile. However, it is also envisaged that the first and second protrusions 135a, 135b may have a J-shaped profile.

The first and second protrusions 135a, 135b may be resiliently deformable. The first protrusion 135a may be resiliently deformable such that the first protrusion 135a may be resiliently deformed by the axial edge 115 of the first rotor shroud structure 112, e.g. when the stator 130 is radially moved into position during assembly or moved out of position during disassembly. Likewise, the second protrusion 135b may be resiliently deformable such that the second protrusion 135b may be resiliently deformed by the axial edge 125 of the second rotor shroud structure 122, e.g. when the stator 130 is radially moved into position during assembly or moved out of position during disassembly. The first and second protrusions 135a, 135b may thus flex past the first and second rotor shroud structures 112, 122 during assembly or disassembly.

The first and second protrusions 135a, 135b may be flexible enough to facilitate assembly past the first and second rotors 110, 120 (e.g. first and second rotor shroud structures 112, 122) without damaging the rotors, whilst also springing back to their natural shape once in position.

The first and second protrusions 135a, 135b may be made from a material that does not damage the first and second rotors 110, 120. The first and second protrusions 135a, 135b may be formed from a fibre-reinforced silicone rubber or any other resilient material. The first and second protrusions 135a, 135b may be at least partially hollow. The first and second protrusions 135a, 135b may comprise a foam filler provided in a hollow of the protrusion.

The first and second protrusions 135a, 135b may be bonded to the shroud ring 134. Alternatively, the first and second protrusions 135a, 135b may be co-cured with the shroud ring 134, e.g. if the shroud ring was moulded. Other ways of connecting the first and second protrusions 135a, 135b (e.g. riveting or a tongue-and-groove geometry between the protrusions and stator shroud structure 132) may also be used in combination with, or instead of, bonding.

Although the first and second protrusions 135a, 135b may be resiliently deformed by the axial edges 115, 125, it is also envisaged that the first and second protrusions 135a, 135b may be configured (e.g. sized) so they do not touch the first and second rotors 110, 120 at the maximum deflection of the first and second protrusions 135a, 135b. In this case, tooling may be used to compress the first and second protrusions 135a, 135b before assembly or disassembly.

In another possible embodiment, the first and second protrusions 135a, 135b may be less flexible (e.g. they may be rigid). If the rotors are split axially (i.e. bolted together), then the stators would also be built axially using ring casings and single-piece shroud rings. As a result, the first and second protrusions 135a, 135b would not have to flex between the rotor platforms and could, therefore, be stiffer. Such stiffer first and second protrusions 135a, 135b may even fill more of the first and second cavities 114, 124 as a smaller running clearance with the rotor could be tolerated.

Regardless, the first and second protrusions 135a, 135b reduce the volume of the first and second cavities 114, 124 and may thereby reduce the back-flow described above in respect of FIG. 3. This may be achieved without adding any weight to the rotatable rotors 110, 120.

The first and second protrusions 135a, 135b may also mitigate aero-acoustic resonances from the first and second cavities 114, 124. By changing their response frequencies, the first and second cavities 114, 124 may no longer interact with other forcing mechanisms from the fluid flow machine.

It will be appreciated that a compressor, turbine, gas turbine engine, vehicle or aircraft may comprise the above-described fluid flow machine or stator shroud structure.

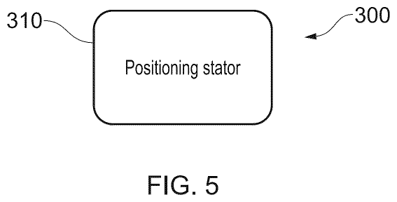

With reference to FIG. 5, there is provided a method 300 of assembling the above-mentioned fluid flow machine. The method comprises positioning 310 the stator 130 such that the first protrusion 135a extends in a direction with an axial component and into the first cavity 114 of the first rotor shroud structure 112. The method may further comprise positioning the stator such that the second protrusion 135b extends in a direction with an axial component and into the second cavity 124 of the second rotor shroud structure 122.

### Other

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein. The present disclosure is also relevant for land, aviation and marine applications in both civil and military contexts.

We claim

1. A fluid flow machine comprising a first rotor and a stator positioned alongside the first rotor, each of the first rotor and the stator comprising a plurality of circumferentially distributed turbomachine blades,
wherein the stator comprises a stator shroud structure comprising a stator shroud surface and the first rotor comprises a first rotor shroud structure comprising a first rotor shroud surface, the stator shroud surface and first rotor shroud surface together at least partially defining a radially inner flow surface of the fluid flow machine,
wherein the first rotor shroud structure defines a first cavity, the first cavity being disposed radially inward of the first rotor shroud surface, the stator shroud structure comprises a first protrusion, the first protrusion being disposed radially inward of the radially inner flow surface, wherein the first protrusion extends in a direction with an axial component and into the first cavity of the first rotor shroud structure, and
wherein the first protrusion is resiliently deformable.

2. The fluid flow machine of claim 1, wherein the first protrusion is resiliently deformable such that the first protrusion is resiliently deformed by an axial edge of the first rotor shroud structure when the stator is radially moved into position during assembly or moved out of position during disassembly.

3. The fluid flow machine of claim 1, wherein the first protrusion is formed from a fibre-reinforced silicone rubber.

4. The fluid flow machine of claim 1, wherein the first protrusion is at least partially hollow.

5. The fluid flow machine of claim 4, wherein the first protrusion comprises a foam filler provided in the hollow of the first protrusion.

6. The fluid flow machine of claim 1, wherein the first protrusion substantially follows the shape of the first cavity.

7. The fluid flow machine of claim 1, wherein the first protrusion extends beyond an axial edge of the first rotor shroud structure such that a distal end of the first protrusion is set back from the axial edge of the first rotor shroud structure when the stator is in an installed position relative to the first rotor.

8. The fluid flow machine of claim 1, wherein the stator shroud structure comprises a shroud ring that supports turbomachine blades of the stator.

9. The fluid flow machine of claim 8, wherein the first protrusion extends from a first end face of the shroud ring.

10. The fluid flow machine of claim 1, wherein the fluid flow machine comprises a seal between the stator shroud structure and the first rotor shroud structure.

11. The fluid flow machine of claim 1, wherein the fluid flow machine further comprises a second rotor comprising a plurality of circumferentially distributed turbomachine blades, the stator being positioned between the first and second rotors,
wherein the second rotor comprises a second rotor shroud structure comprising a second rotor shroud surface, the stator shroud surface and first and second rotor shroud surfaces together at least partially defining the radially inner flow surface of the fluid flow machine,
wherein the second rotor shroud structure defines a second cavity, the second cavity being disposed radially inward of the second rotor shroud surface, and
wherein the stator shroud structure comprises a second protrusion, the second protrusion being disposed radially inward of the radially inner flow surface, wherein the second protrusion extends in a direction with an axial component and into the second cavity of the second rotor shroud structure.

12. A stator shroud structure for a fluid flow machine comprising a stator and a first rotor, the stator shroud structure being configured to support a plurality of circumferentially distributed turbomachine blades,
wherein the stator shroud structure comprises a stator shroud surface at least partially defining a radially inner flow surface of the fluid flow machine,
wherein the stator shroud structure comprises a first protrusion, the first protrusion being disposed radially inward of the radially inner flow surface, wherein the first protrusion extends in a direction with an axial component and beyond an edge of the stator shroud surface.

13. A compressor, turbine, gas turbine engine, vehicle or aircraft comprising the fluid flow machine of claim 1.

14. A method of assembling a fluid flow machine comprising a first rotor and a stator positionable alongside the first rotor, each of the first rotor and the stator comprising a plurality of circumferentially distributed turbomachine blades,
wherein the stator comprises a stator shroud structure comprising a stator shroud surface and the first rotor comprises a first rotor shroud structure comprising a first rotor shroud surface, the stator shroud surface and first rotor shroud surface together at least partially defining a radially inner flow surface of the fluid flow machine,
wherein the first rotor shroud structure defines a first cavity, the first cavity being disposed radially inward of the first rotor shroud surface, and
wherein the stator shroud structure comprises a first protrusion, the first protrusion being disposed radially inward of the radially inner flow surface,
the method comprising positioning the stator such that the first protrusion extends in a direction with an axial component and into the first cavity of the first rotor shroud structure.
